(19) United States
(12) Patent Application Publication
(10) Pub. No.: US 2024/0226718 A1
(43) Pub. Date: Jul. 11, 2024

(54) USER INPUT VALIDITY CLASSIFICATION AND PROCESSING FOR INPUT/OUTPUT (I/O) DEVICES

(71) Applicant: Dell Products L.P., Round Rock, TX (US)

(72) Inventors: Ryan Nicholas Comer, Round Rock, TX (US); Tyler Ryan Cox, Austin, TX (US); Jason Scott Morrison, Chadron, NE (US)

(73) Assignee: Dell Products L.P., Round Rock, TX (US)

(21) Appl. No.: 18/150,791

(22) Filed: Jan. 5, 2023

(51) Int. Cl. A63F 13/23; G06F 13/10

(52) U.S. Cl. CPC A63F 13/23; G06F 13/105

(57) ABSTRACT

Systems and methods described herein may provide a system that enables improved input classification and processing for I/O devices. In one aspect, a computing device may receive interaction data from an I/O device. The interaction data may be associated with a first user interaction. The computing device may classify, with a first model and based on the interaction data, the first user interaction as an invalid input and may reject the first user interaction. In certain aspects, the computing device is the I/O device.

### FIELD OF THE DISCLOSURE

The instant disclosure relates to information handling systems. More specifically, portions of this disclosure relate to techniques for receiving and validating user inputs via I/O devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In some embodiments, the aspects described herein may be used to support the execution of gaming applications in different environments. Gaming sessions may execute on a service, either locally on a device, on another system on the network, or in the cloud. A device may access the gaming session by executing an application that communicates with the service to receive and transmit user input to the service and provide feedback to the user from the service. The device may include its own audio/visual (AV) output for displaying a graphical user interface and/or a rendered display from the gaming session. Different environments at a location may include different AV systems, and the device may be automatically paired with an AV system and may be reconfigured to support interaction with an application session using the paired AV system.

A user's home is one example location that may have multiple environments, such as a living room, a dining room, a study, and/or a bedroom, each with different screen configurations, speaker configurations, and/or network availability. Aspects of embodiments disclosed herein may provide a system that enables game play from a set of candidate game hosts and environments to consumption devices of a user's choice while the user moves about their home between the different environments. The system may employ methods to determine where a user is located within the home, availability and selection of candidate game hosting and target environments, homing and direction of related I/O, and/or AV for consumption. The system then migrates the user and their information to the determined environment by coordinating gameplay by the user. The solution accommodates multiple users simultaneously within the home, whether in single player, multiplayer using the same screen, or multiplayer using separate screen games. The solution may configure AV and input/output (I/O) such that multiple users can consume one or multiple games in the home simultaneously, whether in separate locations or when seated together in front of the same consumption device, e.g., a large television, where multiple games might be hosted simultaneously.

The mobility of a user between services and applications for executing an application session may be supported by an information handling system that uses available telemetry from multiple sources to build a confidence-based knowledge graph of the user's gaming environments and determine a position of the user within that graph. A system with knowledge of devices in a user's gaming environment may build a knowledge graph by aggregating and comparing telemetry. For example, network telemetry may reveal that devices are positioned relatively near each other, a mobile device may reveal an absolute location based on GPS data, and/or an infrared presence sensor may reveal that the user is sitting in front a device. An intelligent system may assemble these individual pieces of telemetry into a broader knowledge graph based on the absolute and/or relative locations of the user's devices, the location of the user in relation, and/or characteristics of the devices. This knowledge graph may be updated in real time and/or based on changes in device telemetry.

According to one embodiment, a method for execution by an information handling system, such as a hub device, includes receiving interaction data from an I/O device, wherein the interaction data is associated with a first user interaction; classifying, with a first model and based on the interaction data, the first user interaction as an invalid input; and rejecting the first user interaction.

In some aspects, the techniques described herein relate to a method, further including, prior to classifying the first user interaction: determining an operating mode for the I/O device; and selecting the first model based on the operating mode of the I/O device.

In some aspects, the techniques described herein relate to a method, wherein the operating mode is determined based on context information regarding a computing process executing on a computing device associated with the I/O device.

In some aspects, the techniques described herein relate to a method, wherein the operating mode identifies a particular application or operational profile for at least a portion of the I/O device.

In some aspects, the techniques described herein relate to a method, wherein the operating mode corresponds to a particular input device on the I/O device.

In some aspects, the techniques described herein relate to a method, wherein the interaction data includes a time series of touch data measured by a touch surface of the I/O device.

In some aspects, the techniques described herein relate to a method, further including: classifying, by the first model, a second user interaction as a valid input within a predetermined time period; and updating the first model based on the second user interaction.

In some aspects, the techniques described herein relate to a method, wherein the invalid input is an input received from a user that is not intended to be received by a computing device coupled to the I/O device.

In some aspects, the techniques described herein relate to a method, wherein the I/O device is a gaming controller.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating aspects of a configurable system for providing services to users according to some embodiments of the disclosure.

FIG. 2 is a block diagram illustrating possible game environments according to some embodiments of the disclosure.

FIG. 3A is a block diagram illustrating application and services hosted in different gaming environments according to some embodiments of the disclosure.

FIG. 3B is a block diagram illustrating application and services hosted in different gaming environments according to some embodiments of the disclosure.

FIG. 3C is a block diagram illustrating application and service hosted in a common gaming environment according to some embodiments of the disclosure.

FIG. 3D is a block diagram illustrating a cloud-based service arrangement for a gaming environment according to some embodiments of the disclosure.

FIG. 4 depicts a system for receiving and processing user input at an I/O device according to an exemplary embodiment of the present disclosure.

FIG. 5A depicts a controller according to an exemplary embodiment of the present disclosure.

FIG. 5B depicts a scroll wheel operating mode for a touch surface according to an exemplary embodiment of the present disclosure.

FIG. 5C depicts a touch interaction according to an exemplary embodiment of the present disclosure.

FIG. 6 depicts a method 600 for receiving and processing user input at an I/O device according to an exemplary embodiment of the present disclosure.

FIG. 7 illustrates an information handling system according to an exemplary embodiment of the present disclosure.

FIG. 7 illustrates an information handling system according to an exemplary embodiment of the present disclosure.

### DETAILED DESCRIPTION

These example embodiments describe and illustrate various aspects of a configurable and dynamic gaming environment that can be supported through the use of a hub device, which may be an information handling system. A hub device may be located in a user's home and used to arrange game play sessions (or more generically application sessions) between host devices and services. The host devices may execute an application for receiving an AV stream for displaying rendered content from a game play session (or other application session), and in some configurations also receive user input for interacting with the session from a peripheral device, such as a gaming controller. The AV stream presented by the host device may be generated by a service. The service may execute on the hub device or another information handling system, such as a cloud computing resource. A home may include one or several host devices (e.g., televisions, mobile computers, tablet computers, and personal computers) and may include one or several information handling systems executing the service (e.g., a hub devices and personal computers).

The user's home may be divided into different environments defined by a space around a host device. For example, a living room with a television may be one environment and a bedroom with a personal computer may be another environment. A user may use a peripheral device in one of the environments and the hub device may configure a host device, a service, and the peripheral device for operation in the environment by determining the corresponding environment using a knowledge graph. The knowledge graph provides a database of historical information about the environments from which the hub device may use current characteristics of the peripheral device to deduce the location, and thus current environment, of the peripheral device. For example, the knowledge graph may include information about location of rooms (e.g., environments) in the house based on wireless signatures of devices within the different rooms. This difference in signatures reflects that a device on one side of the house may receive beacon signals from different neighboring access points than a device on an opposite side of the house. When a user carries the peripheral device around the house, the hub device may determine a location of the peripheral device based on visible access points to the peripheral device. Other example characteristics beyond wireless signature for determining location are described in further detail below, and the knowledge graph may be used to combine different characteristics to identify the location, and thus environment, of the peripheral device.

Based on the location of the peripheral device determined from the knowledge graph, the hub device may initialize an application session for the peripheral device by determining an appropriate host device and service for the application session. For example, if the peripheral device is in the living room and is requesting a game that is within the capabilities of the service on the hub device to execute, the hub device may initialize an application session for the peripheral device between the television as a consumption device and the hub device as a service. The service on the hub device executes the game and streams rendered content to an application executing on the television consumption device.

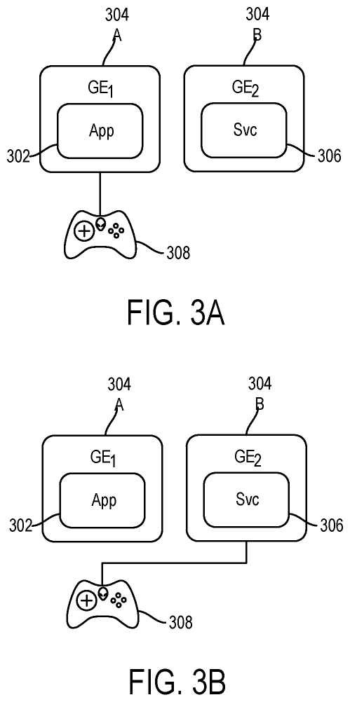

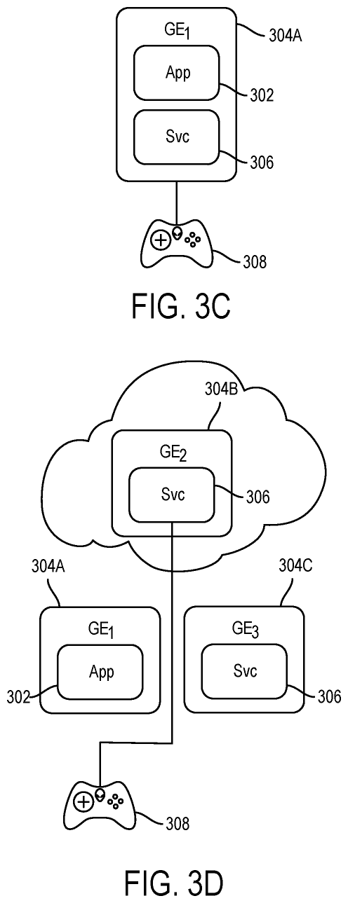

The hub device may be used to migrate the peripheral device to a different environment and/or migrate the application session between host devices and/or services. For example, initially the application session may use a communication link between the peripheral device and the television host device for receiving user input, in which the application executing on the television host device relays user input to the service through a backhaul communication link from the television host device to the hub device. During the application session, the hub device may monitor characteristics of the peripheral device, including signal strength of connection to other components, and determine that the communication link from the peripheral device to the hub device is stronger than the communication link from the peripheral device to the television host device. The hub device may migrate the peripheral device to a communications link with the hub device such that the service executing on the hub device directly receives the user input but the streaming session continues from the service to the application executing on the television host device. Such a change is illustrated in the change in configuration from FIG. 3A to the configuration of FIG. 3B described in further detail below.

Other aspects of the application session may also be migrated. For example, if the peripheral device is determined to move to a different environment, then the hub device may migrate the application session to an application executing on a host device within the new environment. As another example, if a connection between the television host device and the service becomes unstable, the hub device may recommend and/or initiate a migration of the application session to a different host device. One scenario for such a migration may be where the television host device is connected through a wireless link to the service in which the wireless link quality is reducing quality of the streaming and a second host device with a wired connection is available in a nearby environment. Each of these example migrations may be determined based on information in the knowledge graph regarding locations of environments and capabilities within those environments. As yet another example, a user may request execution of an application, such as a particular game, during the application session for which a better configuration exists than the current host device and/or current service. The request for a different application, such as a game or other application requiring a certain GPU capability, may cause the hub device to determine that a second device executing a second service is better for hosting the application and migrate the peripheral device to the second service by, for example, reconfiguring network connections.

The hub device may support connecting to multiple peripheral devices. In one example, the hub device may support two peripheral devices using a shared session on one host device to play the same or different games on the host device. In another example, the hub device may support two peripheral devices in different environments using different sessions with different host devices. The hub device may determine the environment of each of the peripheral devices based on characteristics of the device and the knowledge graph and configure application sessions for each of the peripheral devices accordingly. Different arrangements of peripherals and players may be supported. For example, one hub device executing a service and one host device executing an application can support a configuration with Game A and one player (P1) with peripheral (C1) and Game B and one player (P2) with peripheral (C2); or can support a configuration with Game A and one player (P1) with peripheral (C1) and Game A and one player (P2) with peripheral (C2); or can support a configuration with Game A and two players (P1, P2) with peripherals (C1, C2).

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen, gaming controller and/or a video display. The information handling system may also include one or more buses operable to transmit communications between the various hardware components.

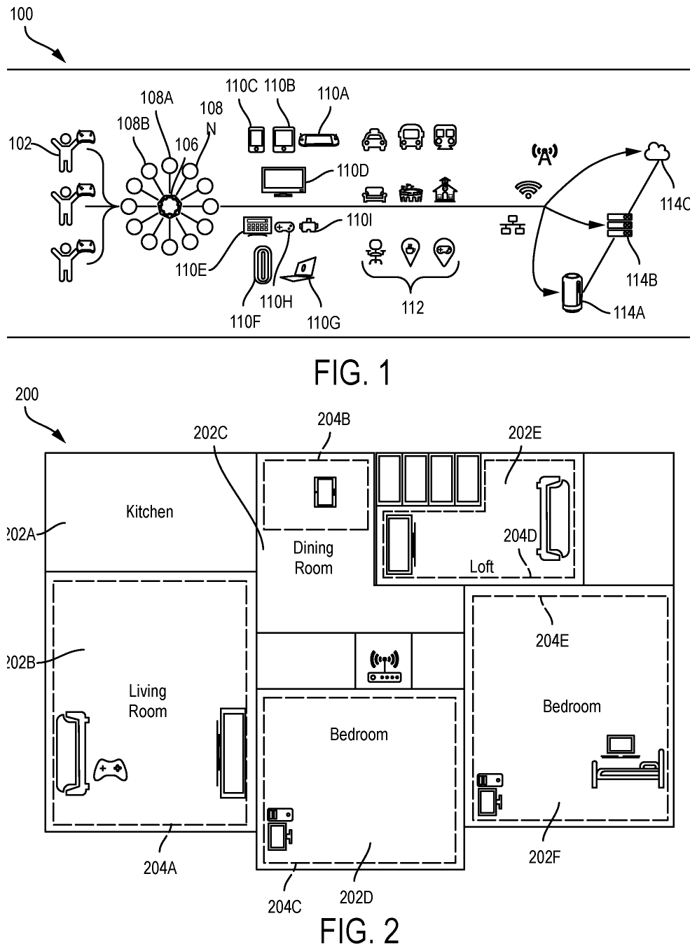

FIG. 1 is a block diagram illustrating aspects of a configurable system for providing services to users according some embodiments of the disclosure. A system 100 includes users 102 who may have access to a shared library of applications 106 including applications 108A-108N. The users 102 may have separate libraries, with some overlapping applications between the libraries. The users 102 may access the library through devices 110A-I, such as mobile gaming device 110A, tablet computing device 110B, phone computing device 110C, television 110D, personal computing device 110E, desktop computing device 110F, laptop computing device 110G, game controller 110H, VR headset 1101. The devices 110 may access services at any of locations 112, including cars, busses, homes, hotels, offices, parks, etc. One or more of the devices 110 may communicate with an application session executing on a computing device 114, such as a home application hub 114A, a server 114B, or a cloud execution environment 114C. In some embodiments, environments may only exist for fixed devices, e.g., desktop computers, televisions, etc.

FIG. 2 is a block diagram illustrating possible game environments according to some embodiments of the disclosure. A user's home 200 may include rooms 202A-F, and each of the rooms may have different information handling systems present, different AV equipment present, and/or different characteristics. For example, a living room 202B may include a large-size television, a bedroom 202D may include a personal computer, and a dining room 202C may include a table computing device. Gaming environments 204A-E in the home 200 may be defined based on spaces where a user is likely to execute an application session. Each gaming environment 204A-E may include numerous devices and gaming environments, devices that may or may not be capable of hosting games, and/or devices that may or may not be capable of receiving game output. A system 100 may allow multiple users in the home 200 to simultaneously execute an application session. In some embodiments, multiple games may be hosted on a single device. In some embodiments, multiple games may target a single output device. In some embodiments, an application or other computing services manages where games should be hosted, where game output should go, and how to best route peripheral I/O for users.

A user may move between gaming environments 204A-E within the home 200 and continue an application session. For example, a user may take a device, such as a gaming controller, from environment 204A to environment 204C. The gaming controller may migrate and reconfigure for operation in environment 204C from a configuration for environment 204A. For example, the controller may transition from an application hosted on a TV in living room 202B to an application hosted on TV in dining room 202C while remaining connected to a host service executing on a PC in bedroom 202D.

Example configurations for applications and services in gaming environments are shown in FIGS. 3A-3D. FIG. 3A is a block diagram illustrating application and services hosted in different gaming environments according to some embodiments of the disclosure. In FIG. 3A, a first gaming environment 304A may include a device, such as a TV or PC, hosting an application 302, which is an endpoint for an application session such as a gaming session. The application 302 communicates with a service 306, which may be hosted on a device in a different gaming environment 304B. A controller 308 may communicate with the application 302 to receive user input for the application session to control, for example, a character in a game. In some embodiments, the controller 308 is connected to the environment 304A hosting the application and the I/O is configured to be relayed to the environment 304B hosting the actual game.

Another arrangement for the application and service is shown in FIG. 3B. FIG. 3B is a block diagram illustrating application and services hosted in different gaming environments according to some embodiments of the disclosure. In FIG. 3B, the controller 308 communicates with the service 306 for providing user input to an application session, with the AV rendering target of the application session being application 302 in a different gaming environment.

Another arrangement for the application and service is shown in FIG. 3C. FIG. 3C is a block diagram illustrating application and service hosted in a common gaming environment according to some embodiments of the disclosure. In FIG. 3C, the application 302 and the service 306 are executed in the same gaming environment 304A, which may be a single device, two devices, or a combination of devices in the gaming environment 304A. The controller 308 may communicate with either the service 306 and/or the application 302.

A further arrangement for the application and service is shown in FIG. 3D. FIG. 3D is a block diagram illustrating a cloud-based service arrangement for a gaming environment according to some embodiments of the disclosure. In FIG. 3D, the controller 308 may communicate with a service 306 hosted in a gaming environment 304B that is remote from the gaming environment 304A in which the application 302 is executing. The service 306 may be executing, for example, on a remote device, such as when the user's home includes the gaming environment 304B but the user is engaging with application 302 at a location on a different network from their home (e.g., at a friend's house). The service 306 may also or alternatively be executed, for example, on a cloud computing device available as a subscription service to the user.

Users may accordingly be able to utilize different computing services (such as gaming services) across different combinations of peripherals, I/O devices, displays, computing devices, and the like. I/O devices, which may conventionally be interacted with by contact or near field interaction, may follow a user as they move between different locations or rooms and thus as the user interacts with different computing devices. To ensure that a user, when interacting with an I/O device, is able to manipulate a desired computing device, it may accordingly be necessary to detect where the I/O device is, and which device should be controlled by inputs to the I/O device. However, when a user is interacting with I/O devices, the user may occasionally interact with the I/O devices accidentally and without intending for corresponding commands to be send to current games or other computing processes. Such problems may be particularly pronounced with touch-based user input devices. The I/O device may accordingly detect an incorrect input event, which may lead to an unintentional action, and a decreased user experience.

One solution to this problem is to use a dynamic input categorization for I/O devices that is able to adapt to individual users and, in certain implementations, to different operating modes for the I/O devices. In certain implementations, the input categorization may be implemented by receiving interaction data (such as time-series interaction data) for a user interaction with an I/O device. The I/O device may analyze the interaction data, such as with a machine learning model, and may classify the user interaction as a valid input or an invalid input. If the interaction is classified as invalid, the I/O device may reject the interaction and may not proceed with processing or otherwise acting on device commands for the user interaction. In certain instances, the model may be updated based on user behavior, such as by monitoring for corrective user interactions shortly after rejecting or allowing user inputs and updating the model when a corrective user interaction is taken (such as repeating an input after an attempted input was incorrectly rejected).

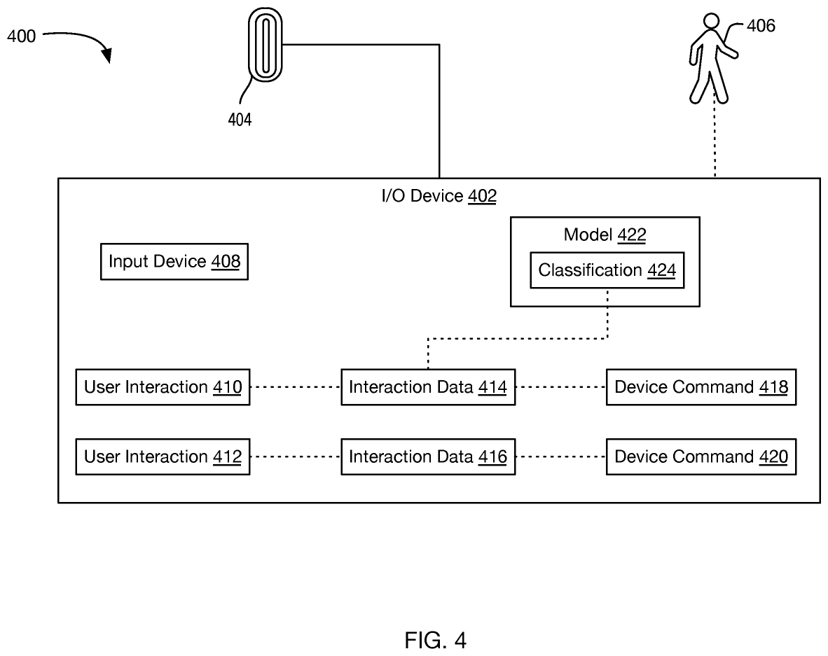

FIG. 4 depicts a system 400 for receiving and processing user input at an I/O device according to an exemplary embodiment of the present disclosure. The system 400 includes a user 406, an I/O device 402, and a computing device 404. The I/O device 402 includes an input device 408, a first user interaction 410, a first interaction data 414, a first device command 418, a second user interaction 412, a second interaction data 416, a second device command 420, and a model 422, which includes a classification 424.

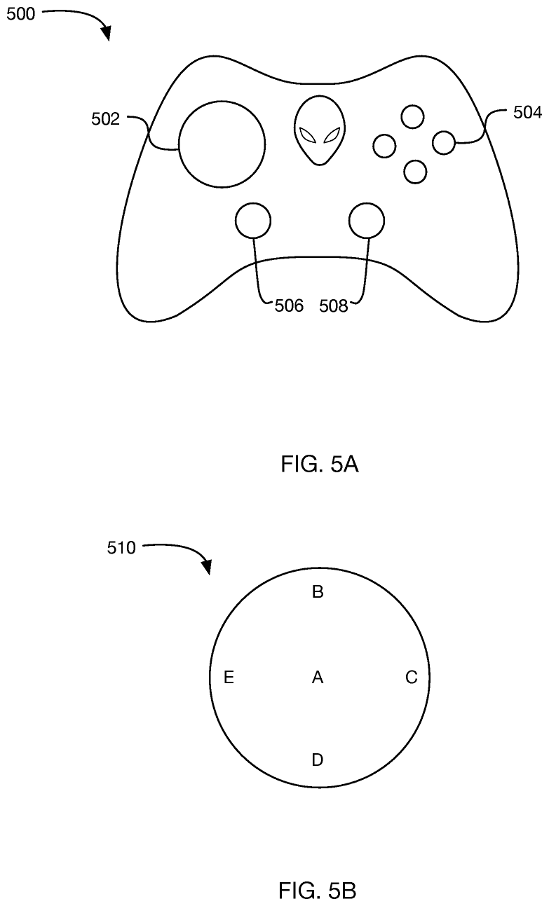

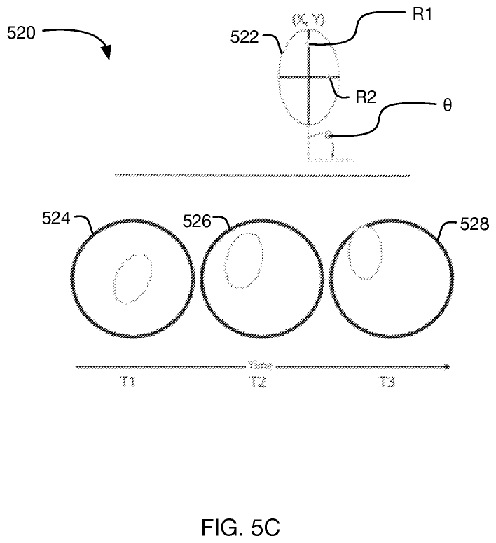

The I/O device 402 may be configured to receive first interaction data 414. The first interaction data 414 may be associated with a first user interaction 410 by a user 406 of the I/O device 402. In certain implementations, the I/O device 402 may be a device capable of sending and receiving information from one or more computing devices (such as one or more personal computing devices, gaming computing devices, gaming consoles, mobile computing devices, displays, and the like). For example, the I/O device 402 may be able to send control information (such as button presses, joystick commands), position information (such as positioning or movement information as the I/O device 402 moves), biometric information (such as from one or more biometric scanners on the I/O device 402), and the like to one or more computing devices 404. The I/O device 402 may receive information from computing devices 404 as well, such as audio information, haptic feedback information, communication status information, and the like. In certain implementations, the I/O device 402 may be a wireless device, such as a device capable of wirelessly communicating with one or more computing devices 404 to send I/O data, receive I/O data, or combinations thereof. In certain implementations, the I/O device 402 may be a gaming controller. In additional or alternative implementations, the I/O device 402 may be one or more of a keyboard, a mouse, a tablet device, a virtual reality (VR) headset, a VR controller, a gaming console (such as a portable gaming console), and the like. In certain implementations, the first interaction data 414 may include information regarding one or more interactions between a user 406 and the I/O device 402. For example, the first interaction data 414 may include sensor data recorded while a user 406 interacted with the I/O device 402 (such as by touching or manipulating one or more input devices 408 on the I/O device 402). For example, the input device 408 may include one or more of a touch surface on the I/O device 402, a key of the I/O device 402, a button of the I/O device 402, an analog stick of the I/O device 402, a trigger of the I/O device 402, a knob of the I/O device 402, and combinations thereof. For example, FIG. 5A depicts a controller 500 according to an exemplary embodiment of the present disclosure. The controller 500 includes multiple input devices, including analog sticks 506, 508, buttons 504, and a touch surface 502. In certain implementations, interactions with the I/O device 402 may include movement of the I/O device 402, and the first interaction data 414 may include sensor measurements (such as from a gyroscope, accelerometer, location sensor, or combinations thereof of the I/O device 402). For example, the controller 500 may include one or more of the above sensors and may be configured to record data using the sensors while in use.

In certain implementations, the first interaction data 414 may include time series data, such as multiple data points received or recorded at multiple times during the first interaction. In certain implementations, the first interaction data 414 may include a time series of touch data measured by a touch surface of the I/O device 402 (such as the touch surface 502). In certain implementations, the touch data may include information regarding an ellipse or other shape indicative of how a user's finger contacts the touch surface (such as the pressure and position of the user's finger). For example, the touch data may include measurements of an ellipse approximating where and how the user's finger contacts the touch surface. In one specific example, FIG. 5C depicts a touch interaction 520 according to an exemplary embodiment of the present disclosure. The touch interaction 520 includes an exemplary touch data point 522, which includes coordinates (x, y) representing a center of where a user comes in contact with the touch surface (forming an ellipse). In addition to the coordinates for the center of the touch location, the touch data point 522 includes two radii R1, R2 defining a shape of the ellipse, and an angle θ off of a vertical axis for the ellipse, which may change over time. Touch interaction 520 also includes a sequence of three touch data points 524, 526, 528 and three different times T1, T2, T3, which may be exemplary time series data points for the first interaction data 414. As shown in FIG. 5C, the touch data points 524, 526, 528 show a touch interaction where the user's 406 finger starts near the center of the touch surface and angled to the right and moves towards the top-left of the touch surface and angled vertically. Specific exemplary data points are shown in Table 1 below.

TABLE 1
Exemplary Touch Data Points

| Time | X (inches) | Y (inches) | R1 (inches) | R2 (inches) | Θ (degrees) |
|---|---|---|---|---|---|
| T1 | 0 | 0 | .5 | .2 | 45 |
| T2 | −.5 | .5 | .7 | .4 | 15 |
| T3 | −.7 | .7 | .5 | .2 | 0 |

In certain implementations, interaction data received by the I/O device 402 may be separated into individual, discrete user interactions (such as the first user interaction 410). In such implementations, the interaction data may be separated into time periods of a predetermined length. For example, interaction data may be recorded or received on a continuous or semi-continuous basis while a user 406 interacts with the I/O device 402. In such instances, individual interactions may be associated with subsets of the received interaction data with the predetermined length (such as 1 second, 0.5 seconds, 0.25 seconds, 0.1 seconds). In additional or alternative implementations, individual interactions 410 may be identified based on when a user 406 stops interacting with the I/O device 402, or a particular input device 408 on the I/O device 402. For example, a user 406 may be resting their finger on a touch surface, which may constitute a first user interaction 410, and a second user interaction 412 may be identified after the user 406 lifts their finger and touches the touch surface again. In such instances, the interaction data 414 may include received input data from before the user 406 lifted their finger and second interaction data 416 corresponding to the second user interaction 412 may include received input data after the user 406 touches the touch surface again. In still further implementations, individual interactions 410, 412 may be identified when input data changes by more than a predetermined amount. In the previous example, rather than waiting for the user 406 to lift their finger, the second user interaction 412 may be identified when the user's 406 finger is determined to move by more than a predetermined amount (such as 5% of the size of the touch surface, 10% of the size of the touch surface, 0.1 inches, 0.05 inches, and the like).

The I/O device 402 may be configured to classify, with a first model 422 and based on the first interaction data 414, the first user interaction 410. For example, the I/O device 402 may be configured to classify user interactions as valid or invalid based on corresponding interaction data. For example, the model 422 may be configured to generate classifications 424 based on interaction data 414, 416, and the classifications 424 may identify the corresponding user interactions 410, 412 as valid or invalid. For example, the model 422 may be implemented as one or more machine learning models, including supervised learning models, unsupervised learning models, other types of machine learning models, and/or other types of predictive models. For example, the model 422 may be implemented as one or more of a neural network, a transformer model, a decision tree model, a support vector machine, a Bayesian network, a classifier model, a regression model, and the like. In particular implementations, the model 422 may be implemented as a long short term memory (LSTM) model.

In certain implementations, valid inputs may be inputs received from a user that are intended to receipt by the computing device 404. In certain implementations, invalid inputs may be inputs received from a user 406 that are not intended to be received by the computing device 404. For example, invalid inputs may include accidental inputs received unintentionally by the I/O device 402 from the user 406. In such instances, the user 406 may not want the input to be provided to the computing device 404, as acting on the input was not intended by the user 406. As one specific example, the user 406 may have unintentionally rested their finger on a touch surface (such as a trackpad or other touch input device 408 on the I/O device 402). This contact may be unintentional, and if the computing device 404 were to act on a command (such as a device command 418) caused by the unintentional contact, the computing device 404 may perform an undesired action (such as sending an unintended click command, triggering an undesired action within a computing application such as a video game, and the like).

The I/O device 402 may be configured to process the first user interaction 410 based on the classification 424. For example, if the first user interaction 410 is classified as valid, the I/O device 402 may transmit a device command 418 based on the interaction data 414 to the computing device 404. The device command 418 may include a corresponding button press, control information, input information, or other command for the computing device 404 to provide to a computing process, such as a video game executing on the computing device 404 or another computing device.

As another example, if the first user interaction 410 is classified as invalid, the I/O device 402 may reject the first user interaction 410. In particular, the I/O device 402 may be configured to refrain from transmitting the invalid command to a coupled computing device 404, which may prevent the undesired action from being taken. For example, the I/O device 402 may disregard the received first interaction data 414 and continue monitoring for additional user 406 input. In certain implementations, I/O device 402 may refrain from transmitting an associated device command 418 to the computing device 404 in response to the classification 424 identifying the first user interaction 410 as invalid. In additional or alternative implementations, the I/O device 402 may refrain from generating the device command 418 at all. As a specific example, if the user 406 is playing a video game and the I/O device 402 is a gaming controller with a touch surface, the user 406 may be resting their finger on the touch surface unintentionally. In such instances, the I/O device 402 may refrain from transmitting commands associated with the touch surface to the coupled computing device 404 until another command or interaction is detected via the touch surface.

In certain implementations, prior to classifying the first user interaction 410, the I/O device may be configured to determine an operating mode for the I/O device 402. In certain implementations, operating modes may identify a particular application or operational profile for at least a portion of the I/O device 402. In certain implementations, particular operating modes may correspond to a particular input device 408 on the I/O device 402. In certain implementations, one or more input devices 408 of the I/O device 402 may be capable of multiple operating modes. For example, a touch surface of the I/O device 402 may be configured to operate in one or more of a scroll wheel mode, a wheel select mode, a swipe mode, a directional pad mode, and a touch mode. In the wheel select mode, different positions within the touch surface may correspond to different menu selections. For example, FIG. 5B depicts a scroll wheel operating mode 510 for a touch surface according to an exemplary embodiment of the present disclosure. In the scroll wheel operating model 510, a user 406 can initially touch a center point A of the touch surface. After touching the point A, a selection menu may be presented within a computing process (such as a computing process executing on or otherwise accessed via the computing device 404). The user 406 may move their finger to corresponding points B-E on the touch surface to select between different options. Once the user 406 has moved their finger to one of the points B-E, the user 406 may click down on the touch surface or lift their finger to indicate selection of the corresponding option within the selection menu. In scroll wheel mode, the touch surface may act like a scroll wheel, with movements of a finger on the touch surface causing scrolling commands to be transmitted to the computing device 404. In a touch mode, the touch surface may transmit cursor movement commands based on movements of a finger on the touch surface. As another example, a trigger of I/O device 402 may be configured to operate in a normal mode and a sensitive mode in which an output command is activated with a shorter pull of the trigger than the normal mode. In certain implementations, the operating mode for the I/O device 402 (such as for at least one input device 408 of the I/O device 402) may be determined based on one or more of user input, context information, or combinations thereof. User input may be received via the I/O device 402, a computing device 404 coupled to the I/O device 402, a computing device (such as a mobile device) associated with the user 406, or combinations thereof. As one specific example, the user 406 may receive a prompt when starting a game to select an operating mode for the touch surface. In certain implementations, the operating mode may be determined based on context information regarding a computing process executing on the computing device 404. In certain implementations, context information may include one or more of information about the user 406, information about how the I/O device 402 is being held, information about a computing service currently in use, or combinations thereof. For example, information about the computing service may include a title of the computing service, a genre of the computing service (such as for video games), a service type for the computing service (such as video games, business applications, word processing applications, communication applications), and a context for the computing service (such as what the user 406 is currently doing within a video game). The context information may also include hand posture or grip strength for how the user is holding the I/O device 402 (such as measured by force or accelerometer settings of the I/O device 402). As one example, a particular video game may typically use a wheel select input to make selections during gameplay. In such instances, the I/O device 402 or another computing device may determine, when the user 406 starts playing the game, that a wheel select operating mode should be used for a touch surface input device. At other times in the same game, a map may be displayed, and it may be advantageous to use the touch surface to move a cursor around the map. In such instances, state information may indicate when the user is viewing a map in the game and, upon determining that a map is being displayed, the I/O device 402 or another computing device may determine that the touch operating mode should be the current operating mode for the touch surface.

In certain implementations, the first model 422 may be selected based on the operating mode of the I/O device 402. In such implementations, different operating modes for the I/O device 402 may have different corresponding models 422. For example, user input patterns may differ when an input device 408 is used for different purposes. In such instances, different models 422 may be required and trained to accurately identify invalid inputs in the different operating modes. The I/O device 402 the coupled computing device 404, and/or another computing device may accordingly store multiple models 422 with identifiers of corresponding operating modes and may select the corresponding model 422 whenever the I/O device 402, or a portion thereof, changes operating modes.

In certain implementations, the I/O device 402 or another computing device may be configured to update the model 422 based on user interactions 410, 412 by the user 406. For example, after rejecting the first user interaction 410 as invalid, the I/O device may receive second interaction data 416 for a second user interaction 412. For example, the user 406 may have been attempting to input a command with the first user interaction 410 that was incorrectly classified as invalid and thus rejected. The user 406 may subsequently enter the intended interaction again as the second user interaction 412 and corresponding second interaction data 416. The second user interaction 412 may be classified, by the model 422, as a valid input (such as based on receiving the same command within a predetermined time period, a change in the interaction data 416, and the like). In such instances, the model 422 may be updated based on the second user interaction 412 and/or the first user interaction 410. In various implementations, the predetermined time period may be 5 seconds or less, 1 second or less, 0.5 seconds or less, 0.1 seconds or less, and the like. The second interaction data 416 may be analyzed by the first model 422, similar to the first interaction data 414 for the first interaction, and the first model 422 may determine that the second user 406 interaction 412 was a valid input based on the second interaction data 416, and may generate and transmit a second device command 420 associated with the second user interaction 412 to the computing device 404. In such instances, the I/O device 402 or another computing device 404 may be configured to update the first model 422 based on the first interaction data 414 and/or the second interaction data 416. When training the model, parameters of the model 422 may be updated based on the corrected input received from the user as the second user interaction 412. In particular, the parameters may include weights (e.g., priorities) for different features and combinations of features. The parameter updates the model 422 may include updating one or more of the features analyzed and/or the weights (such as one or more LSTM thresholds) assigned to different features or combinations of features (e.g., relative to the current configuration of the model 422). In certain implementations, similar processes may be repeated to correct when the model 422 incorrectly classifies user 406 interactions as valid, such as when a user abandons an interaction that was incorrectly started by an unintended, invalid input within a predetermined time period. In certain implementations, a model 422 used for a particular I/O device 402 and a particular operating mode may be selected as a default model for that I/O device 402 and/or operating mode. Over time, as the model 422 is updated based on the user's 406 interactions during use, the model 422 may be trained to more accurately classify inputs based on how the user 406 actually uses the I/O device 402.

The above-discussed techniques enable more accurate classification of user interactions with I/O devices. The improved classifications may decrease false-positive input events for certain types of input devices, such as touch surfaces, and ensure that invalid inputs are accurately rejected. The classifications can also account for the different operating modes that an I/O device may be used for, allowing for differences in user input during the different operating modes to be correctly accounted for. Furthermore, models can be configured and customized to users' actual usage patterns while the I/O device is in use, without requiring separate input from the user and without interrupting the user's computing sessions.

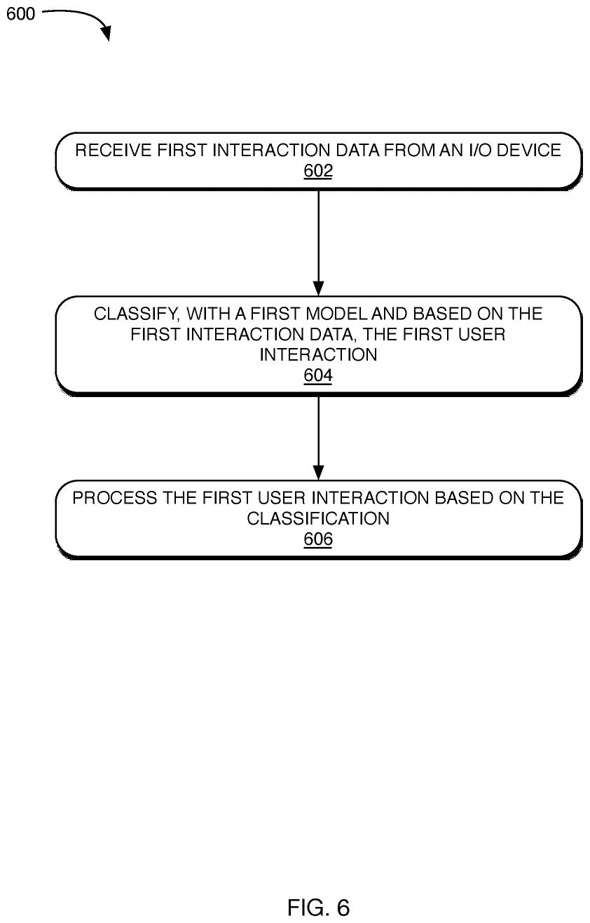

FIG. 6 depicts a method 600 for receiving and processing user input at an I/O device according to an exemplary embodiment of the present disclosure. The method 600 may be implemented on a computer system, such as the system 400. For example, the method 600 may be implemented by the I/O device 402. The method 600 may also be implemented by a set of instructions stored on a computer readable medium that, when executed by a processor, cause the computing device to perform the method 600. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks may be optional.

The method 600 includes receiving first interaction data from an I/O device (block 602). For example, the I/O device 402 may receive first interaction data 414 from an I/O device 402, the first interaction data 414 may be associated with a first user interaction 410. In certain implementations, the I/O device 402 may be a gaming controller. In certain implementations, the first interaction data 414 may include information regarding one or more interactions between a user 406 and the I/O device 402. For example, the first interaction data 414 may include sensor data recorded while a user 406 interacted with the I/O device 402. In certain implementations, the first interaction data 414 may include time series data, such as multiple data points received or recorded at multiple times during the first user interaction 410. In certain implementations, the first interaction data 414 may include a time series of touch data measured by a touch surface of the I/O device 402.

The method 600 includes classifying, with a first model and based on the first interaction data, the first user interaction (block 604). For example, the I/O device 402 may classify, with a first model 422 and based on the first interaction data 414, the first user interaction 410. As noted above, the model 422 may generate a classification for the first user interaction 410 indicating whether the first user interaction 410 represents a valid input or an invalid input. In certain implementations, invalid inputs may be inputs received from a user 406 that are not intended to be received by a computing device 404 coupled to the I/O device 402.

The method 600 includes processing the first user interaction based on the classification (block 606). For example, the I/O device 402 may process the first user interaction 410 based on the classification 424. Processing user interactions may include generating and transmitting device commands to the computing device 404 for valid inputs and may include rejecting invalid commands (such as by rejecting device commands associated with invalid inputs, refraining from generating device commands for invalid inputs, and the like.

In certain implementations, the method 600 may further include, prior to classifying the first user interaction 410, determining an operating mode for the I/O device 402 and selecting the model 422 based on the operating mode. In certain implementations, the method 600 may further include classifying, by the first model 422, a second user interaction 412 as a valid input within a predetermined time period of classifying the first user interaction 410 as valid. In such instances, the method 600 may include updating the first model 422 based on the second user interaction 412.

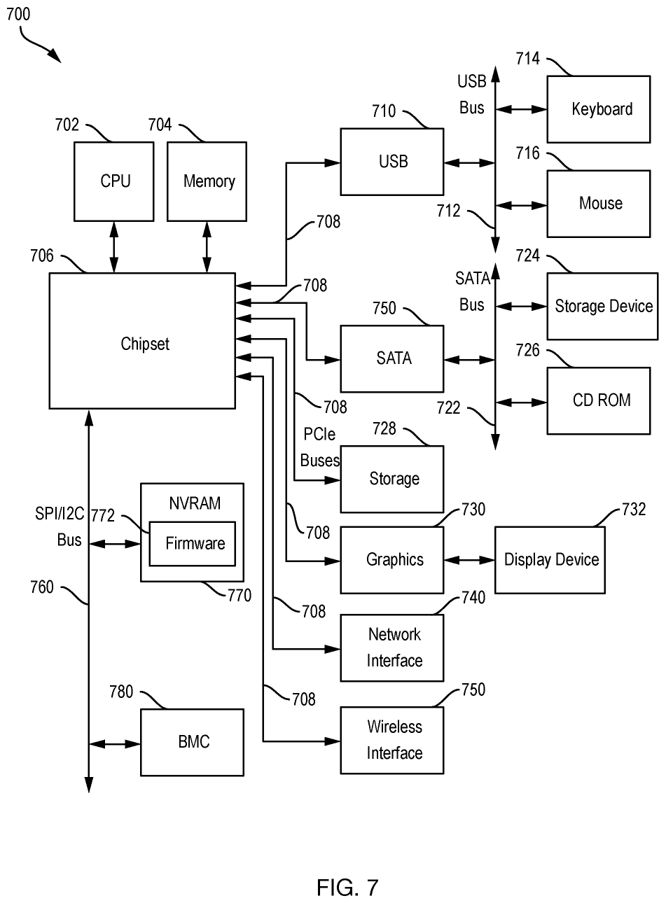

FIG. 7 illustrates an example information handling system 700. Information handling system 700 may include a processor 702 (e.g., a central processing unit (CPU)), a memory (e.g., a dynamic random-access memory (DRAM)) 704, and a chipset 706. In some embodiments, one or more of the processor 702, the memory 704, and the chipset 706 may be included on a motherboard (also referred to as a mainboard), which is a printed circuit board (PCB) with embedded conductors organized as transmission lines between the processor 702, the memory 704, the chipset 706, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 702, the memory 704, the chipset 706, and/or other components may be organized as a System on Chip (SoC).

The processor 702 may execute program code by accessing instructions loaded into memory 704 from a storage device, executing the instructions to operate on data also loaded into memory 704 from a storage device, and generate output data that is stored back into memory 704 or sent to another component. The processor 702 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 702 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 706 may facilitate the transfer of data between the processor 702, the memory 704, and other components. In some embodiments, chipset 706 may include two or more integrated circuits (ICs), such as a northbridge controller coupled to the processor 702, the memory 704, and a southbridge controller, with the southbridge controller coupled to the other components such as USB 710, SATA 720, and PCIe buses 708. The chipset 706 may couple to other components through one or more PCIe buses 708.

Some components may be coupled to one bus line of the PCIe buses 708, whereas some components may be coupled to more than one bus line of the PCIe buses 708. One example component is a universal serial bus (USB) controller 710, which interfaces the chipset 706 to a USB bus 712. A USB bus 712 may couple input/output components such as a keyboard 714 and a mouse 716, but also other components such as USB flash drives, or another information handling system. Another example component is a SATA bus controller 720, which couples the chipset 706 to a SATA bus 722. The SATA bus 722 may facilitate efficient transfer of data between the chipset 706 and components coupled to the chipset 706 and a storage device 724 (e.g., a hard disk drive (HDD) or solid-state disk drive (SDD)) and/or a compact disc read-only memory (CD-ROM) 726. The PCIe bus 708 may also couple the chipset 706 directly to a storage device 728 (e.g., a solid-state disk drive (SDD)). A further example of an example component is a graphics device 730 (e.g., a graphics processing unit (GPU)) for generating output to a display device 732, a network interface controller (NIC) 740, and/or a wireless interface 750 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 706 may also be coupled to a serial peripheral interface (SPI) and/or Inter-Integrated Circuit (I2C) bus 760, which couples the chipset 706 to system management components. For example, a non-volatile random-access memory (NVRAM) 770 for storing firmware 772 may be coupled to the bus 760. As another example, a controller, such as a baseboard management controller (BMC) 780, may be coupled to the chipset 706 through the bus 760. BMC 780 may be referred to as a service processor or embedded controller (EC). Capabilities and functions provided by BMC 780 may vary considerably based on the type of information handling system. For example, the term baseboard management system may be used to describe an embedded processor included at a server, while an embedded controller may be found in a consumer-level device. As disclosed herein, BMC 780 represents a processing device different from processor 702, which provides various management functions for information handling system 700. For example, an embedded controller may be responsible for power management, cooling management, and the like. An embedded controller included at a data storage system may be referred to as a storage enclosure processor or a chassis processor.

System 700 may include additional processors that are configured to provide localized or specific control functions, such as a battery management controller. Bus 760 can include one or more busses, including a Serial Peripheral Interface (SPI) bus, an Inter-Integrated Circuit (I2C) bus, a system management bus (SMBUS), a power management bus (PMBUS), or the like. BMC 780 may be configured to provide out-of-band access to devices at information handling system 700. Out-of-band access in the context of the bus 760 may refer to operations performed prior to execution of firmware 772 by processor 702 to initialize operation of system 700.

Firmware 772 may include instructions executable by processor 702 to initialize and test the hardware components of system 700. For example, the instructions may cause the processor 702 to execute a power-on self-test (POST). The instructions may further cause the processor 702 to load a boot loader or an operating system (OS) from a mass storage device. Firmware 772 additionally may provide an abstraction layer for the hardware, such as a consistent way for application programs and operating systems to interact with the keyboard, display, and other input/output devices. When power is first applied to information handling system 700, the system may begin a sequence of initialization procedures, such as a boot procedure or a secure boot procedure. During the initialization sequence, also referred to as a boot sequence, components of system 700 may be configured and enabled for operation and device drivers may be installed. Device drivers may provide an interface through which other components of the system 700 can communicate with a corresponding device. The firmware 772 may include a basic input-output system (BIOS) and/or include a unified extensible firmware interface (UEFI). Firmware 772 may also include one or more firmware modules of the information handling system. Additionally, configuration settings for the firmware 772 and firmware of the information handling system 700 may be stored in the NVRAM 770. NVRAM 770 may, for example, be a non-volatile firmware memory of the information handling system 700 and may store a firmware memory map namespace of the information handling system 700. NVRAM 770 may further store one or more container-specific firmware memory map namespaces for one or more containers concurrently executed by the information handling system.

Information handling system 700 may include additional components and additional busses, not shown for clarity. For example, system 700 may include multiple processor cores (either within processor 702 or separately coupled to the chipset 706 or through the PCIe buses 708), audio devices (such as may be coupled to the chipset 706 through one of the PCIe busses 708), or the like. While a particular arrangement of bus technologies and interconnections is illustrated for the purpose of example, one of skill will appreciate that the techniques disclosed herein are applicable to other system architectures. System 700 may include multiple processors and/or redundant bus controllers. In some embodiments, one or more components may be integrated together in an integrated circuit (IC), which is circuitry built on a common substrate. For example, portions of chipset 706 can be integrated within processor 702. Additional components of information handling system 700 may include one or more storage devices that may store machine-executable code, one or more communications ports for communicating with external devices, and various input and output (I/O) devices, such as a keyboard, a mouse, and a video display.

In some embodiments, processor 702 may include multiple processors, such as multiple processing cores for parallel processing by the information handling system 700. For example, the information handling system 700 may include a server comprising multiple processors for parallel processing. In some embodiments, the information handling system 700 may support virtual machine (VM) operation, with multiple virtualized instances of one or more operating systems executed in parallel by the information handling system 700. For example, resources, such as processors or processing cores of the information handling system may be assigned to multiple containerized instances of one or more operating systems of the information handling system 700 executed in parallel. A container may, for example, be a virtual machine executed by the information handling system 700 for execution of an instance of an operating system by the information handling system 700. Thus, for example, multiple users may remotely connect to the information handling system 700, such as in a cloud computing configuration, to utilize resources of the information handling system 700, such as memory, processors, and other hardware, firmware, and software capabilities of the information handling system 700. Parallel execution of multiple containers by the information handling system 700 may allow the information handling system 700 to execute tasks for multiple users in parallel secure virtual environments.

The schematic or flow chart diagrams of FIG. 6 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Machine learning models, as described herein, may include logistic regression techniques, linear discriminant analysis, linear regression analysis, artificial neural networks, machine learning classifier algorithms, or classification/regression trees in some embodiments. In various other embodiments, machine learning systems may employ Naive Bayes predictive modeling analysis of several varieties, learning vector quantization artificial neural network algorithms, or implementation of boosting algorithms such as Adaboost or stochastic gradient boosting systems for iteratively updating weighting to train a machine learning classifier to determine a relationship between an influencing attribute, such as received device data, and a system, such as an environment or particular user, and/or a degree to which such an influencing attribute affects the outcome of such a system or determination of environment.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving interaction data from an I/O device, wherein the interaction data is associated with a first user interaction;
classifying, with a first model and based on the interaction data, the first user interaction as an invalid input, wherein the invalid input comprises an accidental input that is not intended as user input; and
rejecting the first user interaction.

2. The method of claim 1, further comprising, prior to classifying the first user interaction:
determining an operating mode for the I/O device; and
selecting the first model based on the operating mode of the I/O device.

3. The method of claim 2, wherein the operating mode is determined based on context information regarding a computing process executing on a computing device associated with the I/O device.

4. The method of claim 2, wherein the operating mode identifies a particular application or operational profile for at least a portion of the I/O device.

5. The method of claim 4, wherein the operating mode corresponds to a particular input device on the I/O device.

6. The method of claim 1, wherein the interaction data includes a time series of touch data measured by a touch surface of the I/O device.

7. The method of claim 1, further comprising:
classifying, by the first model, a second user interaction as a valid input within a predetermined time period; and
updating the first model based on the second user interaction.

8. The method of claim 1, wherein the invalid input is an input received from a user that is not intended to be received by a computing device coupled to the I/O device.

9. The method of claim 1, wherein the I/O device is a gaming controller.

10. An information handling system, comprising:
a memory; and
a processor coupled to the memory, wherein the processor is configured to perform operations comprising:
receiving interaction data from an I/O device, wherein the interaction data is associated with a first user interaction;
classifying, with a first model and based on the interaction data, the first user interaction as an invalid input, wherein the invalid input comprises an accidental input that is not intended as user input; and
rejecting the first user interaction.

11. The information handling system of claim 10, wherein the operations further comprise, prior to classifying the first user interaction:
determining an operating mode for the I/O device; and
selecting the first model based on the operating mode of the I/O device.

12. The information handling system of claim 11, wherein the operating mode is determined based on context information regarding a computing process executing on a computing device associated with the I/O device.

13. The information handling system of claim 11, wherein the operating mode identifies a particular application or operational profile for at least a portion of the I/O device.

14. The information handling system of claim 10, wherein the interaction data includes a time series of touch data measured by a touch surface of the I/O device.

15. The information handling system of claim 10, wherein the operations further comprise:
classifying, by the first model, a second user interaction as a valid input within a predetermined time period; and
updating the first model based on the second user interaction.

16. A non-transitory, computer-readable medium storing instructions which, when executed by a processor, cause the processor to perform operations, comprising:
receiving interaction data from an I/O device, wherein the interaction data is associated with a first user interaction, wherein the I/O device comprises a touch-based user input device;
classifying, with a first model and based on the interaction data, the first user interaction as an invalid input, wherein the invalid input is an accidental input comprising a contact on a touch surface of the I/O device that has been received for more than a predetermined period; and
rejecting the first user interaction.

17. The non-transitory, computer-readable medium of claim 16, wherein the operations further comprise, prior to classifying the first user interaction:
determining an operating mode for the I/O device; and
selecting the first model based on the operating mode of the I/O device.

18. The non-transitory, computer-readable medium of claim 17, wherein the operating mode is determined based on context information regarding a computing process executing on a computing device associated with the I/O device.

19. The non-transitory, computer-readable medium of claim 17, wherein the operating mode identifies a particular application or operational profile for at least a portion of the I/O device.

20. The non-transitory, computer-readable medium of claim 16, wherein the operations further comprise:
classifying, by the first model, a second user interaction as a valid input within a predetermined time period after receiving the first user interaction, the second user interaction corresponding to the first user interaction; and
updating the first model based on the second user interaction.
